(19) United States
(12) Patent Application Publication
(10) Pub. No.: US 2026/0237394 A1
(43) Pub. Date: Aug. 13, 2026

(54) METHOD, SYSTEM AND VEHICLE FOR IMMERSIVE AUDIO REPRODUCTION

(71) Applicant: HARMAN BECKER AUTOMOTIVE SYSTEMS GMBH, Karlsbad (DE)

(72) Inventor: Grzegorz SIKORA, Dachau (DE)

(73) Assignee: HARMAN BECKER AUTOMOTIVE SYSTEMS GMBH, Karlsbad (DE)

(21) Appl. No.: 19/535,108

(22) Filed: Feb. 10, 2026

(30) Foreign Application Priority Data
Feb. 11, 2025 (EP) 25157226.9

(51) Int. Cl. G10L 21/0208

(52) U.S. Cl. CPC G10L 21/0208; G10L 2021/02082

(57) ABSTRACT

A method of modifying an audio signal, a system comprising a processor operable to carry out the method, and a vehicle comprising a processor operable to carry out the method. The method comprising receiving an audio signal and extracting reverberation characteristics from the audio signal, the reverberation characteristics comprising a plurality of parameters. The method further comprising generating an artificial reverberation, the artificial reverberation comprising at least one of the parameters and applying the artificial reverberation to the audio signal. The method further comprising sending a modified audio signal to a plurality of speakers, the modified audio signal comprising the artificial reverberation applied to the audio signal.

### CROSS-REFERENCE TO RELATED APPLICATIONS

This application claims priority to European Patent Application No. 25157226.9 filed Feb. 11, 2025, the disclosure of which is hereby incorporated in its entirety by reference herein.

### TECHNICAL FIELD

The present invention relates to a method, a system, and a vehicle for immersive audio reproduction. In particular, the invention relates to a method of modifying an audio signal, a system comprising a plurality of speakers and a processor operable to modify an audio signal, and a vehicle comprising a plurality of speakers and a processor operable to modify an audio signal.

### BACKGROUND

Conventional multi-loudspeaker systems (for example, audio and/or hi-fi systems in vehicles and other enclosed rooms) during playback of recorded medio often struggle to accurately recreate the spatial cues and reverberant characteristics present in the original recording. This shortcoming can lead to a lack of fidelity and a diminished sense of immersion for a listener.

Current approaches at providing a sense of immersion for a listener come with a multitude of drawbacks. For example, providing a predefined synthetic reverb to media during playback of that media involves adding synthetically generated reverberation on top of the original audio signal (e.g., the original recording). The synthetic reverb may be designed to mimic the characteristics of specific physical acoustic spaces (such as concert halls or jazz clubs). However, this approach disregards the natural reverberation that is already present in the original recording. As a result, the reproduced sound may deviate from the artistic intent of the source material.

A different approach is to attempt to preserve the original recording’s natural reverberation by extracting (for example, by using Quantum Logic Surround) reverberation from the audio signal and then distributing it across a system’s loudspeakers. While this approach aims for greater fidelity by staying true to the original reverb, the extraction process has large computational requirements that are often too demanding and expensive for computers (such as electronic control unit(s) ECUs found in vehicles). Accordingly, the use of such an arrangement in practice leads to a significantly degraded audio quality due to signal processing artifacts.

Accordingly, there is a need in the industry to provide a high quality reproduction of reverberation from an original recording with low computational requirements.

### SUMMARY

To achieve the above objectives, the invention sets out a method, a system, and a vehicle as in the claims below.

In a preferred embodiment, a method of modifying an audio signal is provided. The method includes receiving an audio signal, extracting reverberation characteristics from the audio signal, the reverberation characteristics comprising a plurality of parameters, and generating an artificial reverberation, the artificial reverberation comprising at least one of the parameters. The method further includes applying the artificial reverb to the audio signal, and sending a modified audio signal to a plurality of speakers, the modified audio signal comprising the artificial reverberation applied to the audio signal.

The present invention offers several advantages over conventional multi-loudspeaker systems. By dynamically recreating the natural reverberation characteristics of the original audio signal, the invention improves the overall fidelity of the reproduced sound. Advantageously, the fidelity and immersiveness of audio reproduction in multi-loudspeaker set-ups (i.e. set-ups including two or more loudspeaker channels) is enhanced. In particular, by extracting the original reverberation characteristics (reverb) from the audio as recorded or as created and by applying an artificial reverberation based on those extracted reverberation characteristics, artificial reverberation is generated that closely mimics the reverberation of the original recording (for example, mimicking a reverb experienced in a concert hall where the audio was originally recorded) because the reverb is generated based on the original audio signal’s characteristics. A high-quality, stable artificial reverberation is generated by the artificial reverberation that closely resembles the natural reverberation characteristics extracted from the original audio signal. This is beneficial in enclosed spaced, such as in vehicles, with multi-loudspeaker set-ups where audio and an accurate recreation of spatial cues can be reproduced that closely resembles audio of the original recording, thus providing an immersive listening experience for a user of the vehicle or the enclosed space.

In an embodiment, the modified audio signal includes a first audio signal and a second audio signal that is different to the first audio signal. The method may further include sending the first audio signal to a first channel, the first channel comprising one or more first speakers of the plurality of speakers, and sending the second audio signal to a second channel, the second channel comprising one or more second speakers of the plurality of speakers.

Advantageously, the method as described above can be applied to multi-channel set-ups (such as stereo and other surround-sound systems). By providing a first audio signal and a second audio signal, the synthetic reverberation signal can be distributed and processed separately for each channel and for each individual loudspeaker of each channel within the multi-speaker system. This processing may involve system tuning and sound design to ensure optimal spatialization and integration with the original audio signal. By distributing and processing the reverberation signal separately for each channel and for each loudspeaker, the phantom centre of the audio, and frontal staging perception, can be adjusted more accurately. This also provides an arrangement in which the width and envelopment of the perceived stage size of the audio recording can be increased or decreased more accurately. For example, both an audio recording for a large stage (such as a recording of a large concert hall) and for a small room (such as a recording in a small jazz hall) and anything in between can be mimicked accurately.

In an embodiment, the first audio signal includes the received audio signal, and the second audio signal includes the modified audio signal.

Advantageously, the original audio signals can be distributed through the front speakers to create a stereo foundation, while the recreated synthetic reverb is added to the side and/or rear loudspeakers. This approach fosters a truly immersive listening experience, enabling the listener to perceive themselves within the acoustic environment of the original recording, while maintaining fidelity of the original recording

In an embodiment, the method further includes sampling the audio signal at a sample rate, wherein the sample rate is at a predetermined frequency or at a dynamically adjusted frequency. The method may further includes extracting the reverberation characteristics from the audio signal at each sample of the audio signal.

By sampling the audio signal at a sample rate and extracting the reverb parameters at each sample of the audio signal, as opposed to extracting reverb signal continuously, computational requirements of a computer/processor are drastically reduced. Moreover, dynamically adjusting the sampling rate (or update frequency) of the extracted reverb parameters allows for the complexity of the extracted reverb parameters to be adjusted depending on the type of audio signal that is being fed into the system at a given time. For example, a recording of a choir in a church may include a large amount of reverb, whereas a studio recording of a singer may include a lower amount of reverb. Computational requirements can also be improved by dynamically adjusting the sample rate (for example, by reducing the sample for audio signals that comprise lower rate of reverberation characteristics changes and by increasing the sample rate for audio signals that comprise higher rate of reverberation characteristics changes). This enables the ability to adjust parameter extraction frequency based on the complexity of the source audio and allows for efficient processing and optimization for different musical styles.

Thus, the ability to dynamically adjust the sampling or update frequency of the extracted reverb parameters based on the complexity of the source audio (asymmetric intervals) allows for optimized processing efficiency, resulting in a more efficient system overall. Accordingly, compared to signal extraction techniques, the present invention allows for the creation of synthetic reverberation with superior audio quality while remaining highly faithful to the original recording's natural reverb. This enables unique sound design scenarios depending on the received audio signal.

In an embodiment, the parameters of the extracted reverb include reverb time (i.e., the length of the reverb which may be an RT60, an RT30 or any other length of the reverb length descriptor), pre-delay, decay shape, high and low frequency damping, a room size, diffusion, width, modulation, spectral density, spectral envelope (frequency-dependent behaviour of the reverberation), early reflection patterns in frequency and time, or any combination of the above.

Advantageously, a plurality of different types of reverb can be accounted for, leading to more realistic reproduction of reverb from the received original audio signal.

In an embodiment, the artificial reverberation further includes applying an equaliser to the audio signal, a delay to the audio signal, a gain to the audio signal, or any combination of the above.

Advantageously, a plurality of different effects can be added, leading to a more realistic reproduction of the original audio signal.

In an embodiment, the artificial reverberation further includes applying a pre-defined reverberation to the audio signal, and subsequently applying the generated artificial reverberation to the audio signal.

By applying a pre-defined reverberation (which may, for example, be based on the music type, the genre, or other metadata) first a substantial computational load is lifted from the system. This is advantageous, for example, in vehicles which may not have high processing computers/processors and other computational capacity. For example, an audio signal that is determined to be of a first genre (such as a live rock concert) may have a pre-defined artificial reverberation applied to it (for example, including standard reverberation of a specific indoor or outdoor venue, and providing emphasis on certain reverberation parameters related to a guitar, vocals and drums). To provide the full immersive experience, the reverberation characteristics may be extracted at a lesser rate (for example, at a low sample rate, or only extracting certain parameters as opposed to all parameters). The artificial reverberation may then be applied on top of the pre-defined reverberation to provide the full immersive listening experience. Advantageously, less computation is required compared to extracting the full reverb signal. Extracting parameters at lower intervals and generating reverb is more efficient. Thus, the extraction and generation process has lower computational requirements.

In an embodiment, the method further includes detecting, by one or more microphones in a/the vehicle, a third audio signal corresponding to speech. The method further includes capturing, by the one or more microphones, the third audio signal. The method further includes adjusting the at least one parameters based on the third audio signal, and generating the artificial reverberation, wherein the artificial reverberation includes the adjusted at least one parameters.

Advantageously, the artificial reverberation can compensate for any speech audio (for example one or more users within a vehicle speaking loudly) and can provide the desired artificial reverberation irrespective of disturbing speech audio within the vehicle cabin.

In a preferred embodiment, a system is provided. The system includes a plurality of speakers and a processor. The processor is operable to receive an audio signal, to extract reverberation characteristics from the audio signal, the reverberation characteristics comprising a plurality of parameters, and to generate an artificial reverberation, the artificial reverberation comprising at least one of the parameters. The processor is further operable to apply the artificial reverberation to the audio signal, and to send a modified audio signal to the plurality of speakers, the modified audio signal comprising the artificial reverberation applied to the audio signal.

Advantageously, a system is provided that can be placed in an enclosed room (for example, a vehicle) that has advantages over conventional multi-loudspeaker systems. By dynamically recreating the natural reverberation characteristics of the original audio signal, the invention improves the overall fidelity of the reproduced sound. Advantageously, the fidelity and immersiveness of audio reproduction in multi-loudspeaker set-ups (i.e. set-ups including two or more loudspeaker channels) is enhanced. In particular, by extracting the original reverberation characteristics (reverb) from the audio as recorded or as created and by applying an artificial reverberation based on those extracted reverberation characteristics, reverb is generated that closely mimics the reverb of the original recording (for example, reproducing a reverb experienced in a concert hall where the audio was originally recorded) because the reverb is generated based on the original audio signal’s characteristics. A high-quality, stable artificial reverberation is generated that closely resembles the natural reverberation characteristics extracted from the original audio signal. This is beneficial in enclosed spaced, such as in vehicles, with multi-loudspeaker set-ups where audio and an accurate recreation of spatial cues can be reproduced that closely resembles audio of the original recording, thus providing an immersive listening experience for a user of the vehicle or the enclosed space.

In an embodiment, the processor is further operable to sample the audio signal at a sample rate, wherein the sample rate is at a predetermined frequency or at a dynamically adjusted frequency, and to extract the reverberation characteristics from the audio signal at each sample of the audio signal.

By sampling the audio signal at a sample rate and extracting the reverb at each sample of the audio signal, as opposed to extracting reverb continuously, computational requirements of a computer/processor are drastically reduced. Moreover, dynamically adjusting the sampling rate (or update frequency) of the extracted reverb parameters allows for the complexity of the extracted reverb parameters to be adjusted depending on the type of audio signal that is being fed into the system at a given time. For example, a recording of a choir in a church may include a large amount of reverb, whereas a studio recording of a singer may include a lower amount of reverb. Computational requirements can also be improved by dynamically adjusting the sample rate (for example, by reducing the sample for audio signals that comprise fewer reverberation characteristics and by increasing the sample rate for audio signals that comprise higher reverberation characteristics). This enables the ability to adjust parameter extraction frequency based on the complexity of the source audio and allows for efficient processing and optimization for different musical styles.

Thus, the ability to dynamically adjust the sampling or update frequency of the extracted reverb parameters based on the complexity of the source audio (asymmetric intervals) allows for optimized processing efficiency, resulting in a more efficient system overall. Accordingly, compared to signal extraction techniques, the present invention allows for the creation of synthetic reverberation with superior audio quality while remaining highly faithful to the original recording's natural reverb. This enables unique tuning scenarios depending on the received audio signal.

In a preferred embodiment, a vehicle is provided, the vehicle including the system as described above.

Advantageously, an immersive listening experience can be recreated in a vehicle. A user of the vehicle can enjoy music in the vehicle as if they were listening to the music in a live manner (such as in a concert hall, a jazz club, etc.).

In an embodiment, the plurality of speakers include a plurality of first speakers coupled to a first channel and a plurality of second speakers coupled to a second channel, and wherein the modified audio signal comprises a first audio signal and a second audio signal that is different to the first audio signal, and the processor is further operable to send the first audio signal to the first channel, and to send the second audio signal to the second channel.

Advantageously, the system as described above can be applied to multi-channel set-ups (such as stereo and other surround-sound systems). By providing a first audio signal and a second audio signal, the synthetic reverberation signal can be distributed and processed separately for each channel and for each individual loudspeaker of each channel within the multi-speaker system. This processing may involve techniques known in the art of system tuning and sound design to ensure optimal spatialization and integration with the original audio signal. By distributing and processing the reverberation signal separately for each channel and for each loudspeaker, the phantom centre of the audio can be adjusted more accurately. This also provides an arrangement in which the width of the perceived stage size of the audio recording can be increased or decreased more accurately. For example, both an audio recording for a large stage (such as a recording of a large concert hall) and for a small room (such as a recording in a small jazz hall) and anything in between can be mimicked accurately.

In an embodiment, the one or more first speakers are located are front facing speakers relative to a user of the vehicle, and the one or more second speakers are side or rear facing speakers relative to the user of the vehicle.

Advantageously, the original audio signals can be distributed dynamically to create a more immersive listening experience to a user.

In an embodiment, the first audio signal includes the received audio signal, and the second audio signal includes the modified audio signal.

Advantageously, the original audio signals can be distributed dynamically through the front speakers to create a stereo foundation, while the recreated synthetic reverb is added to the side and/or rear loudspeakers. This approach fosters a truly immersive listening experience, enabling the listener to perceive themselves within the acoustic environment of the original recording.

In an embodiment, the vehicle includes at least one microphone. The microphone is operable to detect a third audio signal corresponding to speech and to capture the third audio signal. The processor is further configured to adjust the at least one parameters based on the third audio signal. The processor is further configured to generating the artificial reverberation, wherein the artificial reverberation includes the adjusted at least one parameters.

Advantageously, the artificial reverberation can compensate for any speech audio (for example one or more users within a vehicle speaking loudly) and can provide the desired artificial reverberation irrespective of disturbing speech audio within the vehicle cabin.

Advantageously, one or more microphones may capture speech in the car cabin, process it with synthetic reverbs, and augment the perception of presence within a vehicle cabin.

### BRIEF DESCRIPTION OF THE DRAWINGS

The features, objects, and advantages of the present disclosure will become more apparent from the detailed description set forth below when taken in conjunction with the drawings in which like reference numerals refer to similar elements.

FIG. 1 shows an example flow diagram of a system and a method of modifying an audio signal including input and output flows for modifying the audio signal according to the invention;

FIG. 2 a shows a system including a computer comprising a processor and memory, a plurality of speakers and a plurality of microphones according to the invention;

FIG. 3 shows a vehicle comprising a plurality of speakers and the computer of FIG. 2 according to the invention;

FIG. 4 depicts a flow chart of a method of modifying an audio signal according to the invention;

FIG. 5 depicts a flow chart of further methods of modifying an audio signal according to alternative embodiments of the invention; and

FIG. 6 depicts a flow chart of further methods of modifying an audio signal according to alternative embodiments of the invention.

### DETAILED DESCRIPTION

This invention is in the field of audio reproduction systems, particularly those employing multiple loudspeakers with two or more channels with an aim to improve the fidelity and perceived immersiveness of the reproduced sound and the sound field (in other words, the perception of the location of sound, and mimicking by the audio reproduction systems the experience of a recorded audio signal at the point in which the audio signal was recorded). The invention is applicable to automotive audio systems and also has broader relevance for any multi-loudspeaker configuration.

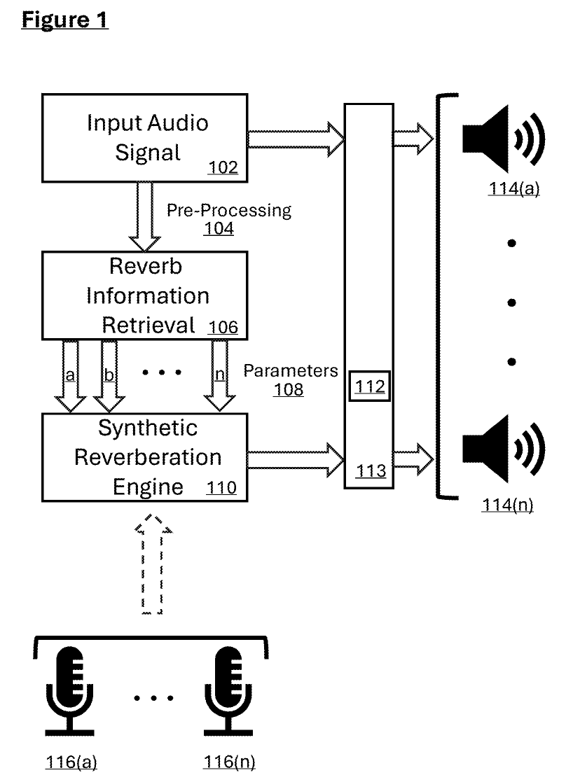

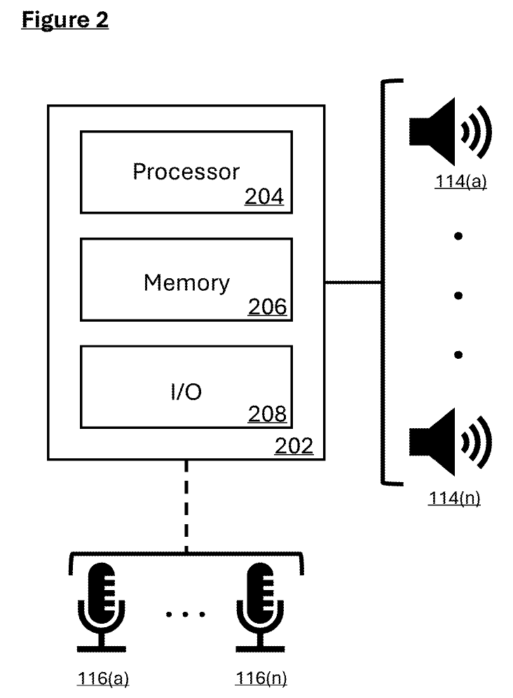

FIG. 1 shows an example flow diagram of a system and a method of modifying an audio signal including input and output flows for modifying the audio signal according to the invention. The method is performed with a computer comprising a processor and memory as referred to in FIG. 2. The computer is coupled to a plurality of loudspeakers 114(a), …114(n) (herein referred to as 114n) and may be coupled to one or more microphones 116(a), … 116(n) (herein referred to as 116n). The method includes receiving an input, such as an audio signal 102 (which may be a multi-channel audio input signal) at a processor. The processor is part of a computer as defined with reference to FIG. 2 below. The audio signal may be a live recording sensed and recorded by one or more microphones (not shown) that are connected to or coupled (for example with a wireless or wired connection) to the processor. Alternatively, the audio signal may be a media file comprising a pre-recorded audio recording that is accessed from a database (for example, an online database, or a local database such as stored on local memory of the computer defined with reference to FIG. 2 below or any other computer connected to or coupled with the computer). The media file may be in any suitable audio format known in the art (for example, MP3, AAC, WAV, or any other suitable audio format). Subsequent to receiving the audio signal, the processor may perform a pre-processing step 104 which may include one or more filtering steps of the audio signal, a fast fourier transform (FFT), and any other pre-processing steps required to provide frequency information about the audio signal.

Subsequent to receiving the audio signal 102, reverberation characteristics are extracted from the audio signal 102 (for example, by the processor as referred to below in FIG. 2). Extracting the reverberation characteristics may include applying (for example, by the processor as referred to in FIG. 2) a reverb information retrieval (RIR) algorithm 106 to the audio signal 102. The RIR algorithm 106 combines deterministic processing techniques and machine learning models to extract a plurality of parameters 108a, 108b, … 108n (herein referred to as 108n to refer to all of the plurality of the parameters 108a, 108b, … 108n). The deterministic processing techniques may include applying one or more of spectral and temporal analysis, one or more audio suppression techniques, spectral editing, one or more subtractive techniques, noise gating, impulse response extraction, linear predictive coding, etc. on the audio signal. The machine learning models may be operable to clean up the extracted reverberation characteristics, for example, by extracting the reverberation characteristics, feeding these into one or more machine learning (and/or artificial intelligence) models to recreate the plurality of parameters 108n. The plurality of parameters 108n fully describe the reverberation embedded within the audio. The RIR algorithm 106 may extract reverb based on models and processing techniques. The plurality of parameters 108 can be extracted based on IR analysis, computation of decay curves for example, by Schroeder Integration Method, statistical processing (such as cross-correlation), Short-Time Fourier Transform for spectra-temporal analysis, peak detection for early reflections, etc.

The extracted reverberation characteristics comprise the plurality of parameters 108n. The parameters 108n may include reverb time (for example, a length of the reverb which may be an RT60, an RT30 or any other length of the reverb length descriptor), pre-delay, decay shape, high and low frequency damping, a room size, diffusion, width, modulation, spectral density, spectral envelope (frequency-dependent behaviour of the reverberation), early reflection patterns in frequency and time, or any combination of the above. Advantageously, a plurality of different types of reverb can be accounted for, leading to a more realistic reproduction of reverb from the received original audio signal.

Subsequent to extracting the reverberation characteristics, an artificial reverberation (for example, a synthetic reverb filter) is generated comprising at least one of the plurality of parameters 108n. The artificial reverberation may be any suitable type of audio filter. Accordingly, the artificial reverberation recreates partially or fully recreates the extracted reverberation characteristics of the original audio signal 102. The artificial reverberation may be generated by a synthetic reverberation engine/processor 110, which may be part of a computer as defined in FIG. 2 (i.e. utilizing part of a processor, memory, and input/output ports). The artificial reverberation may include only one of the parameters 108n, some of the parameters 108n (i.e. two or more parameters), or all of the parameters 108n. Accordingly, a reverb filter may be generated to produce any type of desired reverb effect. For example, this may be limited to one type of reverb (for example, only accommodating reverb time and/or spectral density), or may encompass a plurality of reverb features (for example, including spectral envelope, early reflection patterns in frequency and time, RT60 or RT30, or any combination of these features).

The generated artificial reverberation is applied to the audio signal 102 to create a modified audio signal. The modified audio signal is sent (for example, by processor as in FIG. 2) to a plurality of speakers 114(a) … 114(n) (herein referred to as 114n) to play back the modified audio signal. The speakers 114n may be part of a single playback arrangement (e.g., a HiFi set, a set of speakers within a vehicle, or similar) or may be part of multiple playback arrangements (e.g., multiple separate HiFi sets in communication with each other). The speakers 114n may be any suitable arrangement capable of reproducing sound. Any one of the speakers 114n may include one or more drivers. The playback arrangement comprising the plurality of speakers 114n be a multi-channel playback system (e.g., a stereo system, a surround sound system, or similar).

This arrangement offers several advantages over conventional multi-loudspeaker systems. By dynamically recreating the natural reverberation characteristics of the original audio signal, the invention improves the overall fidelity of the reproduced sound. Advantageously, the fidelity and immersiveness of audio reproduction in multi-loudspeaker systems (i.e. systems including two or more loudspeaker channels) is enhanced. In particular, by extracting the original reverberation characteristics (reverb) from the audio as recorded or as created and by applying an artificial reverberation based on those extracted reverberation characteristics, reverb is generated that closely mimics the reverb of the original recording (for example, reproducing a reverb experienced in a concert hall where the audio was originally recorded) because the reverb is generated based on the original audio signal’s characteristics. A high-quality, stable artificial reverberation is generated by the artificial reverberation that closely resembles the natural reverberation characteristics extracted from the original audio signal. This is beneficial in enclosed spaced, such as in vehicles, with multi-loudspeaker systems where audio and an accurate recreation of spatial cues can be reproduced that closely resembles audio of the original recording, thus providing an immersive listening experience for a user of the vehicle or the enclosed space.

In an embodiment, the modified audio signal may include a plurality of different audio signals. For example, the modified audio signal may include a first audio signal and a second audio signal that is different to the first audio signal. As mentioned above, the plurality of speakers 114n may be set-up in a multi-channel arrangement (for example, a stereo system, a surround sound system, or similar). Sending, from the computer as defined in FIG. 2, the modified audio signal to the plurality of speakers 114n may further include sending the first audio signal to a first channel of the multi-channel arrangement, the first channel comprising one or more first speakers 114a of the plurality of speakers 114n. Sending the modified audio signal to the plurality of speakers 114n may further include sending the second audio signal to a second channel of the multi-channel arrangement, the second channel comprising one or more second speakers 114b of the plurality of speakers 114n.

Advantageously, the modified signal as described above can be applied to multi-channel set-ups (such as stereo and other surround-sound systems). By providing a first audio signal and a second audio signal, the synthetic reverberation signal can be distributed and processed separately for each channel and for each individual loudspeaker of each channel within the multi-speaker system. This processing may involve system tuning and sound design to ensure optimal spatialization and integration with the original audio signal. By distributing and processing the reverberation signal separately for each channel and for each loudspeaker, the phantom centre of the audio can be adjusted more accurately. This also provides an arrangement in which the width of the perceived stage size of the audio recording can be increased or decreased more accurately. For example, both an audio recording for a large stage (such as a recording of a large concert hall) and for a small room (such as a recording in a small jazz hall) and anything in between can be mimicked accurately.

The first audio signal may be the received audio signal wherein the received audio signal does not include any spatial and/or reverberation processing) and the second audio signal may be the modified audio signal that may include mostly artificial reverberation. Advantageously, the original audio signals can be distributed through the front speakers to create a stereo foundation, while the recreated synthetic reverb is added to the side and/or rear loudspeakers. This approach fosters a truly immersive listening experience, enabling the listener to perceive themselves within the acoustic environment of the original recording.

In an embodiment, the synthetic reverberation engine 110 may apply at least one additional filter 112 to the audio signal before sending the modified audio signal to the plurality of speakers 114n. The additional filters 112 may include an equaliser to the audio signal, a delay to the audio signal, a gain to the audio signal, or any combination of the above. The at least one additional filter 112 may be applied to the first audio signal (i.e. the received audio signal), the second audio signal (i.e. the modified signal), any further audio signal, or to any one or more of the audio signals within the modified audio signal. The additional filter 112 may be different for of the audio signals within the modified audio signal. Advantageously, a plurality of different effects and filters can be added to the audio signal, leading to a more realistic reproduction of the original audio signal.

In an embodiment, the system may include an audio matrix adder 113 (for example, an audio matrix, a matrix mixer, a digital audio matrix, or any other suitable mixer. The audio matrix adder 113 may be coupled between the computer (for example, computer 202 as described below in FIG. 2) and the plurality of loudspeakers 114. The audio matrix adder 113 is operable to receive the input audio signal 102 and the modified audio signal before either the input audio signal 102 or the modified audio signal are sent to the plurality of loudspeakers 114. The audio matrix adder 113 is operable to mix the input audio signal 102 and the modified audio signal and subsequently to distribute the mixed audio signal (which includes the input audio signal 102 and the modified audio signal) to each of the plurality of loudspeakers. The mixed audio signal may include a plurality of different types of audio signals. Accordingly, different audio signals can be sent to different ones of the plurality of loudspeakers. In an embodiment, the mixed audio signal may include the first audio signal and the second audio signal as described above. In an embodiment, the additional filter 112 may be integrated within the audio matrix adder 113.

In an embodiment, the synthetic reverberation engine 110 may first apply a pre-defined n reverberation (for example, a pre-defined artificial reverberation) to the audio signal 102 and subsequently apply the generated artificial reverberation. The pre-defined reverberation may take into account one or more of parameters 108n described above. The parameters 108n of the pre-defined reverberation may each be pre-determined and not based on the extracted reverberation characteristics. A plurality of different pre-defined reverberations may be stored on memory of a computer (as referred to in FIG. 2 below). Each of the pre-defined reverberations may be applied to different scenarios. For example, a first pre-defined reverberation may be applied to classical music, a second pre-defined reverberation may be applied to jazz music, a third pre-defined reverberation may be applied to music recorded in a studio, a fourth pre-defined reverberation may be applied to music recorded at a live concert hall, a fifth pre-defined reverberation may be applied to a combination of the above, etc. The processor (as defined in FIG. 2) may determine which pre-defined reverberation should be applied to the received audio signal 102 from the audio signal’s metadata (for example, received from a network sending the audio signal, or metadata stored on a physical copy associated with the audio signal). The metadata may be related to a music genre, a music theme, a location of recording, an artist name, etc. The pre-defined reverberation may alternatively be selected by a user.

The pre-defined reverberation may be applied to the audio signal to create a modified audio signal comprising the received audio signal and the pre-defined reverberation. The synthetic reverberation engine 110 may compare this modified audio signal with the extracted reverberation characteristics of the received audio signal. The synthetic reverberation engine 110 may detect one or more differences in the parameters 108n of the pre-defined reverberation to the parameters 108n of the extracted reverberation characteristics. Subsequently, the synthetic reverberation engine 110 may generate the artificial reverberation based on the differences in the parameters 108n of the pre-defined reverberation to the parameters 108n of the extracted reverberation characteristics.

By applying a pre-defined reverberation (which may, for example, be based on the music type, the genre, or other metadata) first a substantial computational load is lifted from the system. This is advantageous, for example, in vehicles which may not have high processing computers/processors and other computational capacity. For example, an audio signal that is determined to be of a first genre (such as a live rock concert) may have a pre-defined filter reverb filter applied to it (for example, including standard reverberation of a specific indoor or outdoor venue, and providing emphasis on certain reverberation parameters related to a guitar, vocals and drums). To provide the full immersive experience, the reverberation characteristics may be extracted at a lesser rate (for example, at a low sample rate, or only extracting certain parameters as opposed to all parameters). The artificial reverberation may then be applied on top of the pre-defined filter to provide the full immersive listening experience. Advantageously, the extraction and generation process has lower computational requirements.

In an embodiment, the processor may sample the audio signal 102 at a sample rate, wherein the sample rate is at a predetermined frequency or at a dynamically adjusted frequency. The frequency may be increased (i.e. more samples are taken per unit of time) when a load on the computer (i.e., the processor, the memory, or a combination of both) is low. The frequency may be decreased (i.e. fewer samples are taken per unit of time) when the load on the computer is high. The frequency may be adjusted dynamically to reflect the current load on the computer as well as a predicted load on the computer. The frequency may be increased for a more complex reverb in the received audio signal. The frequency may be decreased for a less complex reverb in the received audio signal. The RIR algorithm may extract the reverberation characteristics from the audio signal at each sample of the audio signal 102. Accordingly, the RIR algorithm extracts the plurality of parameters 108n at a predetermined frequency, which can be either fixed or dynamically adjusted based on the complexity of the reverb in the source audio. Music genres with minimal changes in reverb characteristics, such as classical or acoustic pieces, may require less frequent parameter extraction compared to genres with more complex and dynamic reverb effects.

By sampling the audio signal at a sample rate and extracting the reverb at each sample of the audio signal, as opposed to extracting reverb continuously, computational requirements of a computer/processor are drastically reduced. Moreover, dynamically adjusting the sampling rate (or update frequency) of the extracted reverb parameters allows for the complexity of the extracted reverb parameters to be adjusted depending on the type of audio signal that is being fed into the system at a given time. For example, a recording of a choir in a church may include a large amount of reverb, whereas a studio recording of a singer may include a lower amount of reverb. Computational requirements can also be improved by dynamically adjusting the sample rate (for example, by reducing the sample for audio signals that comprise fewer reverberation characteristics and by increasing the sample rate for audio signals that comprise higher reverberation characteristics). This enables the ability to adjust parameter extraction frequency based on the complexity of the source audio and allows for efficient processing and optimization for different musical styles.

Thus, the ability to dynamically adjust the sampling or update frequency of the extracted reverb parameters based on the complexity of the source audio (asymmetric intervals) allows for optimized processing efficiency, resulting in a more efficient system overall. Accordingly, compared to signal extraction techniques, the present invention allows for the creation of synthetic reverberation with superior audio quality while remaining highly faithful to the original recording's natural reverb. This enables unique tuning scenarios depending on the received audio signal.

In an embodiment, one or more microphones 116n may be coupled (wirelessly or wired) the synthetic reverberation engine 110. The one or more microphones 116n may detect a third audio signal corresponding to speech and, subsequently, capture (i.e., record) the third audio signal and send the third audio signal to the synthetic reverberation engine 110. The synthetic reverberation engine 110 may adjusting the at least one parameter 108 based on the third audio signal. For example the speech within the car may have an adverse effect on reverberation characteristics within the vehicle cabin (e.g., by distorting the reverberation). The synthetic reverberation engine 110 may generate an artificial reverberation that compensates for the speech within the vehicle cabin and, thus, provides artificial reverberation that mimics the extracted reverberation characteristics/parameters, irrespective of the speech within the cabin. The synthetic reverberation engine 110 may generating the artificial reverberation, wherein the artificial reverberation includes the adjusted at least one parameter. Advantageously, the artificial reverberation can compensate for any speech audio (for example one or more users within a vehicle speaking loudly) and can provide the desired artificial reverberation irrespective of disturbing speech audio within the vehicle cabin.

FIG. 2 shows an exemplary system of a computer 202 comprising a processor 204, memory 206, and an input/output (I/O) interface 208. The computer 202 is coupled (by means of a wired or wireless connection to the plurality of speakers 114n as defined above with reference to FIG. 1. The computer 202 may be coupled (by means of a wired or wireless connection) to one or more microphones 116n as defined above with reference to FIG. 1. The processor 204 is operable to carry out a set of actions and/or instructions which may be stored on the memory 206. The computer 202 may be a standalone unit dedicated to carry out the method and steps as defined above in FIG. 1. The computer 202 may be operable to carry out a plurality of separate features in addition to the method and steps as defined above in FIG. 1. For example, the computer 202 may be an electronic control unit (ECU) or part of an ECU of a vehicle (for example, in direct communication with an ECU by means of a wireless or wired connection).

The processor 204 may apply the RIR algorithm 106 as defined above in FIG. 1. The processor 204 may comprise the synthetic reverb engine 110 as defined above in FIG. 1 and may carry out the steps performed by the synthetic reverb engine 110. The I/O interface 208 may include one or more input ports and one or more output ports. The one or more input ports may comprise wired and/or wireless connections operable to receive an input audio signal 102 as defined above with reference to FIG. 1. The one or more input ports may be in wired or wireless communication with a network, operable to receive one or more instructions from the network. The one or more input ports may be operable to receive an input signal from the one or more microphones 116n. The one or more output ports may be in wired or wireless connection to the one or more loudspeakers 114n and operable to transmit or transfer an audio signal (such as the input audio signal 102, the modified audio signal as defined above, or any other type of audio signal) from the computer 202 to the one or more loudspeakers 114n.

In an embodiment the processor 204 is operable to receive an audio signal 102 and to extract reverberation characteristics from the audio signal 102 (for example, by applying the RIR algorithm 106), wherein the reverberation characteristics comprise the plurality of parameters 108n. The processor 204 is further operable to generate (for example, by the synthetic reverberation engine 110) an artificial reverberation, the artificial reverberation comprising at least one of the parameters 108n. The processor 204 is further operable to apply the artificial reverberation to the audio signal 102. In other words, the processor 204 is operable to generate a modified audio signal, the modified audio signal comprising the artificial reverberation applied to the audio signal 102. The processor 204 is further operable to send the modified audio signal to the plurality of speakers 114n (for example, by sending the modified audio signal to one or more output ports of the I/O interface 208).

Advantageously, a system is provided that can be placed in an enclosed room (for example, a vehicle) that has advantages over conventional multi-loudspeaker systems. By dynamically recreating the natural reverberation characteristics of the original audio signal, the invention improves the overall fidelity of the reproduced sound. Advantageously, the fidelity and immersiveness of audio reproduction in multi-loudspeaker set-ups (i.e. set-ups including two or more loudspeaker channels) is enhanced. In particular, by extracting the original reverberation characteristics (reverb) from the audio as recorded or as created and by applying an artificial reverberation based on those extracted reverberation characteristics, reverb is generated that closely mimics the reverb of the original recording (for example, reproducing a reverb experienced in a concert hall where the audio was originally recorded) because the reverb is generated based on the original audio signal’s characteristics. A high-quality, stable artificial reverberation is generated by the artificial reverberation that closely resembles the natural reverberation characteristics extracted from the original audio signal. This is beneficial in enclosed spaced, such as in vehicles, with multi-loudspeaker set-ups where audio and an accurate recreation of spatial cues can be reproduced that closely resembles audio of the original recording, thus providing an immersive listening experience for a user of the vehicle or the enclosed space.

In an embodiment, the processor 204 is further operable to sample the audio signal 102 at a sample rate, wherein the sample rate is at a predetermined frequency or at a dynamically adjusted frequency, and to extract the reverberation characteristics from the audio signal at each sample of the audio signal as discussed above with reference to FIG. 1.

By sampling the audio signal at a sample rate and extracting the reverb at each sample of the audio signal, as opposed to extracting reverb continuously, computational requirements of a computer/processor are drastically reduced. Moreover, dynamically adjusting the sampling rate (or update frequency) of the extracted reverb parameters allows for the complexity of the extracted reverb parameters to be adjusted depending on the type of audio signal that is being fed into the system at a given time. For example, a recording of a choir in a church may include a large amount of reverb, whereas a studio recording of a singer may include a lower amount of reverb. Computational requirements can also be improved by dynamically adjusting the sample rate (for example, by reducing the sample for audio signals that comprise fewer reverberation characteristics and by increasing the sample rate for audio signals that comprise higher reverberation characteristics). This enables the ability to adjust parameter extraction frequency based on the complexity of the source audio and allows for efficient processing and optimization for different musical styles.

Thus, the ability to dynamically adjust the sampling or update frequency of the extracted reverb parameters based on the complexity of the source audio (asymmetric intervals) allows for optimized processing efficiency, resulting in a more efficient system overall. Accordingly, compared to signal extraction techniques, the present invention allows for the creation of synthetic reverberation with superior audio quality while remaining highly faithful to the original recording's natural reverb. This enables unique tuning scenarios depending on the received audio signal.

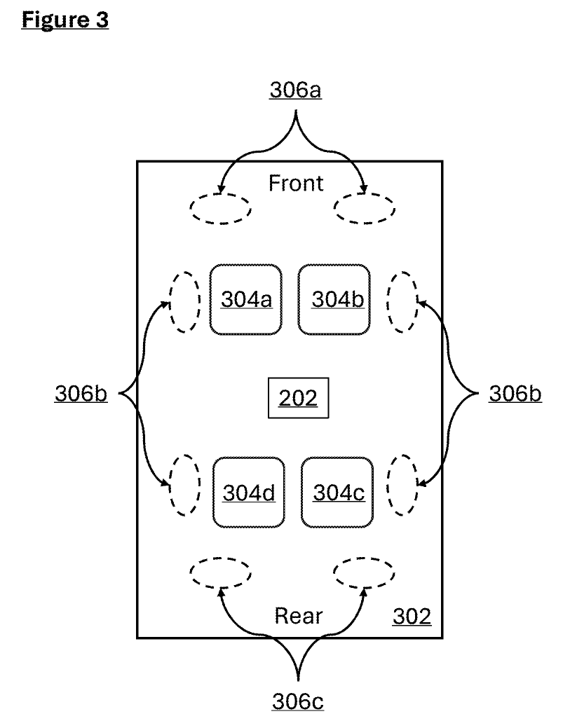

FIG. 3 shows a vehicle 302 comprising the computer 202 as defined in FIG. 2, a plurality of speakers 306a, 306b, 306c within the cabin of the vehicle 302, the plurality of speakers 306a, 306b, 306c corresponding to the plurality of speakers 114n defined in FIGS. 1 and 2, and a plurality of seats for vehicle occupants 304a, 304b, 304c, 304d. FIG. 3 depicts an exemplary arrangement of four seats for vehicle occupants 304a, 304b, 304c, 304d in a two-by-two arrangement. However, the invention is not limited to four seats or to the arrangement as shown in FIG. 3 and may include a single seat for a vehicle occupant or any number of seats for a plurality of vehicle occupants. Accordingly, the vehicle may be any land, water or airborne vehicle with an enclosed space for any number of occupants such as (but not limited to), automobiles, buses, lorries, aircraft vehicles, boats, ships, hovercraft, etc. The computer 202 is depicted in FIG. 3 as being positioned in a central position of the vehicle 302. However, the invention is not limited to this arrangement and the computer 202 may be placed anywhere within the vehicle 302 such that the computer 202 can communicate (by means of a wired or wireless connection) with the plurality of speakers 306a, 306b, 306c and such that the computer may communicate with one or more microphones 116n within the cabin of the vehicle 302 as defined in FIGS. 1 and 2 (not shown in FIG. 3).

FIG. 3 depicts two speakers 306a at a front side of the vehicle’s cabin (i.e. front facing relative to the one or more occupants of the vehicle 302), two speakers 306c at the rear side of the vehicle’s cabin (i.e. rear facing relative to the one or more occupants of the vehicle 302), two speakers 306b on a left side of the vehicle’s cabin (i.e. facing to the left side relative to the one or more occupants of the vehicle 302), and two speakers 306b on a right side of the vehicle’s cabin (i.e. facing to the right side relative to the one or more occupants of the vehicle 302). The eight speaker set-up shown in FIG. 3 is for exemplary purposes and the invention is not limited to eight speakers as in FIG. 3. The invention may include any number of (i.e. one or more) front speakers 306a, rear speakers 306b, left speakers 306b, or right speakers 306b. The invention may include only front speakers 306a, rear speakers 306b, left speakers 306b, right speakers 306b, or any combination thereof. The invention may include different speakers at locations not shown in FIG. 3 (for example, located below one or more vehicle occupants, above one or more vehicle occupants, diagonal to one or more vehicle occupants, etc.).

By providing a vehicle 302 comprising the computer 202 as defined in FIG. 2, and the plurality of loudspeakers 306a, 306b, 306c an immersive listening experience can be recreated in the vehicle 302. A user of the vehicle 302 can enjoy music in the vehicle 302 as if they were listening to the music in a live manner (such as in a concert hall, a jazz club, etc.).

In an embodiment, the plurality of speakers 306a, 306b, 306c can include a plurality of channels. For example, the plurality of speakers 306a, 306b, 306c can be partitioned into stereo set-up wherein the speakers on a left side of the vehicle cabin playback a first version of the modified audio signal (as defined above) and the speakers on a right side of the vehicle cabin playback a second version of the modified audio signal to reproduce a stereo set-up. The plurality of speakers 306a, 306b, 306c may include a plurality of first speakers (such as the left speakers 306b, one or more of the front speakers 306a on a left side of the vehicle cabin, one or more of the rear speakers 306c on the left side of the vehicle cabin, or any combination thereof) coupled to a first channel and a plurality of second speakers (such as the right speakers 306b, one or more of the front speakers 306a on a right side of the vehicle cabin, one or more of the rear speakers 306c on the right side of the vehicle cabin, or any combination thereof) coupled to a second channel. The invention is not limited to this arrangement and may include any number of channels, for example, to reproduce a surround-sound set-up (such as a 5.1, 7.1, 9.1, or similar surround sound set-up). The modified audio signal (as defined above in FIGS. 1 and 2) may include a first audio signal and a second audio signal that is different to the first audio signal and the processor 204 of the computer 202 may be operable to send the first audio signal to the first channel and to send the second audio signal to the second channel.

Advantageously, the system as described above can be applied to multi-channel set-ups (such as stereo and other surround-sound systems). By providing a first audio signal and a second audio signal, the synthetic reverberation signal can be distributed and processed separately for each channel and for each individual loudspeaker of each channel within the multi-speaker system. This processing may involve techniques known in the art of system tuning and sound design to ensure optimal spatialization and integration with the original audio signal. By distributing and processing the reverberation signal separately for each channel and for each loudspeaker, the phantom centre of the audio can be adjusted more accurately. This also provides an arrangement in which the width of the perceived stage size of the audio recording can be increased or decreased more accurately. For example, both an audio recording for a large stage (such as a recording of a large concert hall) and for a small room (such as a recording in a small jazz hall) and anything in between can be mimicked accurately.

Alternatively or additionally, the plurality of speakers 306a, 306b, 306c can be split into a plurality of front facing speakers relative to the occupants of the vehicle (for example, including front speakers 306a, one or more of the left and right speakers 306b in a front location of the vehicle cabin relative to the occupants of the vehicle 302, or any combination thereof) coupled to a first channel, and a plurality of rear facing speakers relative to the occupants of the vehicle (for example, including rear speakers 306c, one or more of the left and right speakers 306b in a rear location of the vehicle cabin relative to the occupants of the vehicle 302, or any combination thereof) coupled to a second channel. The modified audio signal (as defined above in FIGS. 1 and 2) may include a first audio signal and a second audio signal that is different to the first audio signal and the processor 204 of the computer 202 may be operable to send the first audio signal to the first channel and to send the second audio signal to the second channel. The plurality of speakers 306a, 306b, 306c may include more than two channels of speakers, and the modified audio signal may include more than two audio signals, depending on the number of channels of speakers. In an embodiment, the plurality of speakers 306a, 306b, 306c can be split into a plurality of front facing speakers (as defined above) coupled to a first channel, and a plurality of side facing speakers relative to the vehicle’s occupants (such as speakers 306b) coupled to a second channel. The processor 204 may be operable to send the first audio signal to the first audio channel and to send the second audio signal to the second channel.

Advantageously, the original audio signals can be distributed dynamically to create a more immersive listening experience to a user.

In an embodiment, the first audio signal may include the received audio signal 102, and the second audio signal includes the modified audio signal as defined above in FIGS. 1 and 2. The first audio signal may include the received audio signal 102 and a partial version of the modified audio signal (for example, a modified audio signal comprising the received audio signal 102 and a the generated artificial reverberation applied at a lower intensity to the received audio signal). The second audio signal may include a predominant playback of reverb generated by the artificial reverberation. This may comprise playing back a modified audio signal which comprises the generated artificial reverberation at a relatively high intensity (or full intensity) and the received audio signal at a relatively low intensity. In an embodiment, the first audio signal may be played back by the rear facing speakers relative to the occupants of the vehicle and the second audio signal may be played back by the front facing speakers relative to the occupants of the vehicle.

Advantageously, the original audio signals can be distributed dynamically through the front speakers to create a stereo foundation, while the recreated synthetic reverb is added to the side and/or rear loudspeakers. This approach fosters a truly immersive listening experience, enabling the listener to perceive themselves within the acoustic environment of the original recording.

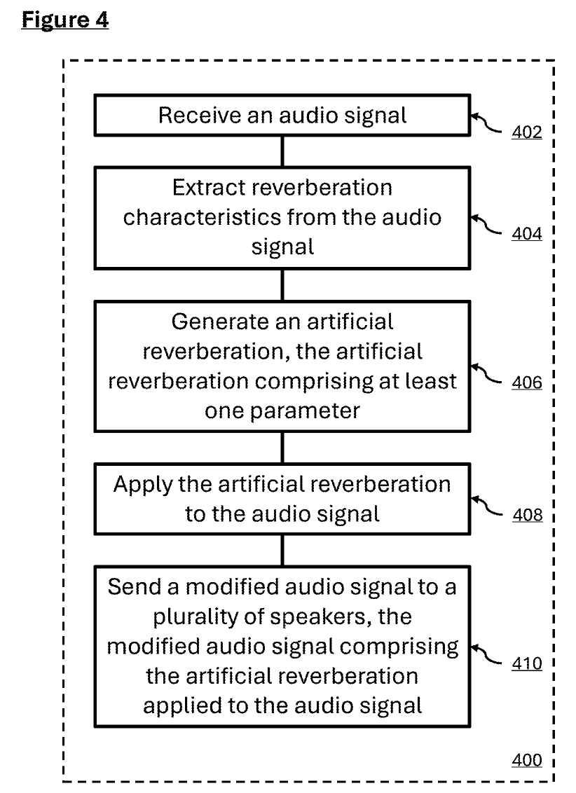

FIG. 4 shows a flow chart of a method 400 of modifying an audio signal, as described above with reference to FIGS. 1, 2 and 3, according to the invention. The method includes receiving an audio signal at 402 (such as audio signal 102 as described above). At 404, the method includes extracting reverberation characteristics from the audio signal (for example with RIR algorithm 106 as described above), the reverberation characteristics comprising a plurality of parameters (such as parameters 108n). The method includes at 406 generating an artificial reverberation (for example, by synthetic reverb engine 110 which may be a part of processor 204 as described above), the artificial reverberation comprising at least one of the parameters. The method further includes at 408 applying the artificial reverberation to the audio signal 102, and at 410 sending a modified audio signal to a plurality of speakers, the modified audio signal comprising the artificial reverberation applied to the audio signal 102.

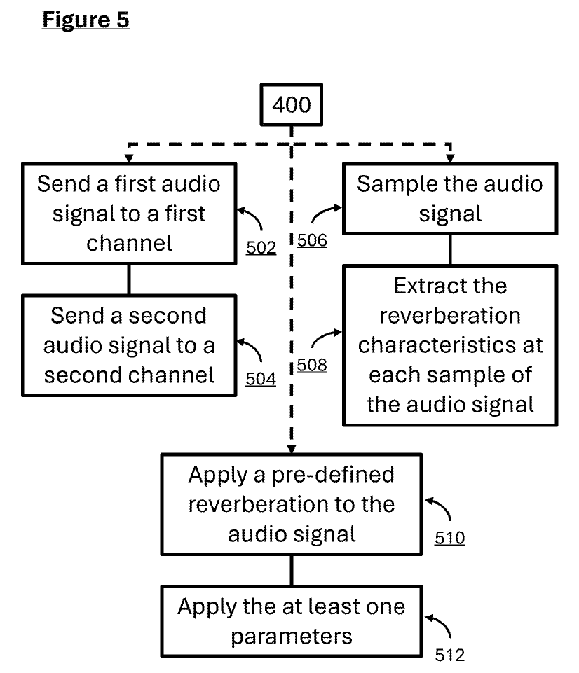

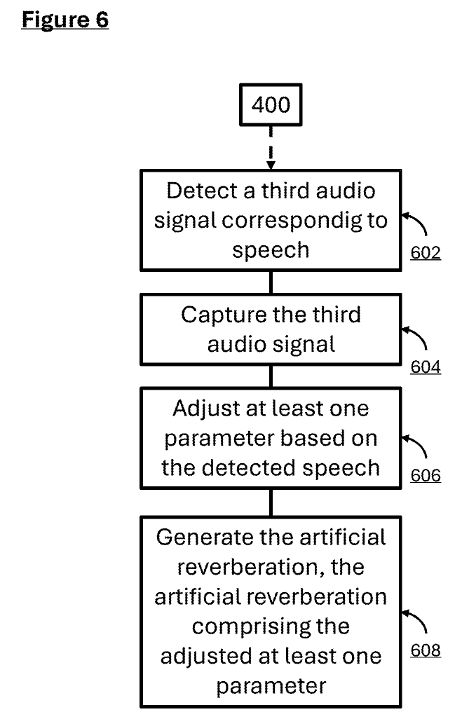

FIGS. 5 and 6 show additional method steps of modifying an audio signal which can be combined with the method as described above with regard to FIG. 4 and with the arrangement as described above with reference to FIGS. 1, 2 and 3.

In FIG. 5, the method may include at 502 sending a first audio signal to a first channel of a plurality of audio channels (as described above), the first channel comprising one or more first speakers of the plurality of speakers (for example of speakers 114n, 306a, 306b, 306c as described above), wherein the modified audio signal includes the first audio signal and a second audio signal that is different to the first audio signal. The method may include at 504 sending the second audio signal to a second channel, the second channel comprising one or more second speakers of the plurality of speakers 114n, 306a, 306b, 306c. In an embodiment, the first audio signal includes the received audio signal, and the second audio signal includes the modified audio signal.

The method may further include at 506 sampling the audio signal at a sample rate, wherein the sample rate is at a predetermined frequency or at a dynamically adjusted frequency. The method may further include at 508 extracting the reverb from the audio signal at each sample of the audio signal.

Applying the artificial reverberation to the audio signal may further include at 510 applying a pre-defined reverberation to the audio signal, and subsequently at 512 applying the generated artificial reverberation to the audio signal.

In FIG. 6, the method may include at 602, detecting (for example, by one or more microphones in the vehicle as described above) a third audio signal corresponding to speech. At 604, the method may include capturing (by the one or more microphones) the third audio signal. At 606, the method may include adjusting the at least one parameters based on the third audio signal. At 608, the method may include generating the artificial reverberation, wherein the artificial reverberation includes the adjusted at least one parameters.

Advantageously, the artificial reverberation can compensate for any speech audio (for example one or more users within a vehicle speaking loudly) and can provide the desired artificial reverberation irrespective of disturbing speech audio within the vehicle cabin.

What is claimed is:

1. A method of modifying an audio signal comprising:
receiving an audio signal;
extracting reverberation characteristics from the audio signal, the reverberation characteristics comprising a plurality of parameters;
generating an artificial reverberation, the artificial reverberation comprising at least one of the parameters;
applying the artificial reverberation to the audio signal; and
sending a modified audio signal to a plurality of speakers, the modified audio signal comprising the artificial reverberation applied to the audio signal.

2. The method of claim 1, wherein the modified audio signal comprises a first audio signal and a second audio signal that is different to the first audio signal, the method further comprising:
sending the first audio signal to a first channel, the first channel comprising one or more first speakers of the plurality of speakers; and
sending the second audio signal to a second channel, the second channel comprising one or more second speakers of the plurality of speakers.

3. The method of claim 2, wherein:
the first audio signal comprises the received audio signal; and
the second audio signal comprises the modified audio signal.

4. The method of claim 1, further comprising:
sampling the audio signal at a sample rate, wherein the sample rate is at a predetermined frequency or at a dynamically adjusted frequency; and
extracting the reverberation characteristics from the audio signal at each sample of the audio signal.

5. The method of claim 1, wherein the parameters of the extracted reverb include at least one of:
reverb time;
pre-delay;
decay shape;
high and low frequency damping;
a room size;
diffusion;
width;
modulation;
spectral density;
spectral envelope;a nd
early reflection patterns in frequency and time.

6. The method of claim 1, wherein applying the artificial reverberation further comprises applying at least one of:
an equaliser to the audio signal;
a delay to the audio signal; and
a gain to the audio signal.

7. The method of claim 6, wherein applying the artificial reverberation further comprises:
applying a pre-defined reverberation to the audio signal; and
subsequently applying the generated artificial reverberation to the audio signal.

8. The method of claim 1, further comprising:
detecting, by one or more microphones in a/the vehicle, a third audio signal corresponding to speech;
capturing, by the one or more microphones, the third audio signal;
adjusting the at least one parameters based on the third audio signal; and
generating the artificial reverberation, wherein the artificial reverberation comprises the adjusted at least one parameters.

9. A system comprising:
a plurality of speakers; and
a processor, the processor operable to:
receive an audio signal;
extract reverberation characteristics from the audio signal, the reverberation characteristics comprising a plurality of parameters;
generate an artificial reverberation, the artificial reverberation comprising at least one of the parameters;
apply the artificial reverberation to the audio signal; and
send a modified audio signal to the plurality of speakers, the modified audio signal comprising the artificial reverberation applied to the audio signal.

10. The system of claims claim 9, the processor is further operable to:
sample the audio signal at a sample rate, wherein the sample rate is at a predetermined frequency or at a dynamically adjusted frequency; and
extract the reverberation characteristics from the audio signal at each sample of the audio signal.

11. A vehicle including a system, comprising:
a plurality of speakers; and
a processor, the processor operable to:
receive an audio signal;
extract reverberation characteristics from the audio signal, the reverberation characteristics comprising a plurality of parameters;
generate an artificial reverberation, the artificial reverberation comprising at least one of the parameters;
apply the artificial reverberation to the audio signal; and
send a modified audio signal to the plurality of speakers, the modified audio signal comprising the artificial reverberation applied to the audio signal.

12. The vehicle of claim 11, wherein the plurality of speakers comprise a plurality of first speakers coupled to a first channel and a plurality of second speakers coupled to a second channel, and wherein the modified audio signal comprises a first audio signal and a second audio signal that is different to the first audio signal, and the processor is further operable to:
send the first audio signal to the first channel; and
send the second audio signal to the second channel.

13. The vehicle of claim 12, wherein:
the one or more first speakers are located are front facing speakers relative to a user of the vehicle; and
the one or more second speakers are side or rear facing speakers relative to the user of the vehicle.

14. The vehicle of claim 13, wherein:
the first audio signal comprises the received audio signal; and
The second audio signal comprises the modified audio signal.

15. The vehicle of claim 11, further comprising:
at least one microphone, the at least one microphone operable to detect a third audio signal corresponding to speech and to capture the third audio signal, wherein the processor is further configured to:
adjust the at least one parameters based on the third audio signal; and
generate the artificial reverberation, the artificial reverberation comprising the adjusted at least one parameters and the parameter based on the third audio signal.
